(19) United States
(12) Patent Application Publication
(10) Pub. No.: US 2009/0157470 A1
(43) Pub. Date: Jun. 18, 2009

(54) METHODS FOR FACILITATING CONTACT INFORMATION CHANGES

(75) Inventors: Darryl T. Rathbun, Stratford, CT (US); Trysh Wahlig, Chicago, IL (US); Theresa Biasi, Shelton, CT (US); G. Jonathan Wolfman, Brattleboro, VT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 11/955,478

(22) Filed: Dec. 13, 2007

(51) Int. Cl. G06F 17/30

(52) U.S. Cl. 705/10

(57) ABSTRACT

A method of facilitating the maintenance of an address list of each of a plurality of mailers wherein master address information based on current address list information received from each of the mailers is maintained, and wherein the mailers are automatically notified of address changes based on change of address information for a plurality of movers provided. Also, a method of facilitating the maintenance of an address list of each of a plurality of mailers in response to a change of address request being provided to a postal service by a mover that specifies a new address for the mover. Finally, a method of assisting a party to notify selected payees of one or more changes in contact related information for the party that is provided in conjunction with an electronic bill payment system through which a party makes payments to the payees.

### FIELD OF THE INVENTION

The invention disclosed herein relates generally to the processes by which mailers maintain address lists of, for example, customers, and in particular to methods which assist in making changes to such address lists.

### BACKGROUND OF THE INVENTION

Maintaining communication with customers or similar contacts is critical for all mailers. This is particularly true during the critical stage when a customer moves, since at that time, their spending typically increases dramatically and they are often in the market for new services. Mailers currently have several resources available to identify customer moves. Such resources, however, are only available after the customer moves and the search must be initiated by the individual mailer. The mailer must then react to the change, possibly after several missed communications with the mover. The only exception is if the mover notifies the mailer directly, but most movers do not immediately do this because it is a time consuming process or they mistakenly think that by notifying the postal service (e.g., USPS), all mailers will be automatically notified as well.

Some of the methods/services that mailers currently use to identify customer moves include Ancillary Service Endorsements (ASE), Address Change Service (ACS™), NCOALink®, or some other custom United States Postal Service (USPS) approved solution. ASE and ACS™ are post-mailing notification methods for returning information to mailers about mailpieces that were not forwarded or that were undeliverable. These notifications may take weeks or even months for the mailer to receive. NCOALink® is a service that may be used to compare a mailer's address list to a database owned and updated by the USPS which contains permanent National Change of Address (NCOA) records filed with the USPS over the last 48 months by employing proprietary matching algorithms. It is up to each mailer to initiate these checks on a regular basis. The problems with the NCOA based methods include the fact that the information is only released periodically (monthly for users or weekly for service providers), the fact that it may take weeks from the time that a mover files a change of address to the time it makes it to an NCOA update, and the fact that they rely on the individual mailers to initiate a check.

Furthermore, even though, as described above, there are a number of resources available for mailers to identify customer moves, many mailers are unwilling to make changes to their address lists without an explicit request from the mover. Such mailers often wish to confirm changes based on account types or numbers and/or other information that is specific to the mailer. Thus, for a mover to make an address change with such a mailer, it is typically necessary for the mailer to find several pieces of information, such as a way to contact the mailer (e.g., phone number, address or web site), an account number and/or recent transaction information (for authentication purposes). The mover will need to find such information for every mailer with which the mover wishes to change their address, which often proves to be difficult and time consuming, particularly since it is often the case that such information is packed away when a mover moves. In addition, while many mailers provide various methods for movers to notify them of a change of address, such as change of address forms on the backs of bills, telephone helpdesks, web sites with an electronic change of address form, and periodic mailings with change of address forms, all of these methods must be initiated by the mover for each individual mailer, which can be time consuming and inconvenient.

Thus, there is a need for one or more methods for updating the address lists of mailers to stay current in light of customer moves and/or for simplifying and facilitating the process by which a mover changes an address or other contact information with one or more mailers.

### SUMMARY OF THE INVENTION

In one embodiment, the invention provides a method of facilitating the maintenance of an address list of each of a plurality of mailers. The method includes maintaining master address information based on current address list information received from each of the mailers, and receiving change of address information specifying a new address for each of a plurality of movers that is based on a change of address filed by each of the movers with a postal service or a third party working on behalf of the postal service. The method further includes comparing the change of address information to the master address information to determine a plurality of matching movers included in both the change of address information and the master address information and providing each of the matching movers with a list of one or more particular ones of the mailers that have the matching mover listed on their current address list. Finally, the method includes for each of one or more responding matching movers: (i) receiving a change of address notification authorization from the responding matching mover which identifies a selected one or more of the mailers included in the list provided to the responding matching mover, and (ii) notifying each of the selected mailers of the new address of the responding matching mover.

In another embodiment, the invention provides a method of facilitating the maintenance of an address list of each of a plurality of mailers in response to a change of address request being provided to a postal service or a third party working on behalf of the postal service by a mover that specifies new contact information (e.g., mailing address, phone number and/or email address) for the mover. The method includes maintaining master address information based on current address list information received from each of the mailers and processing the mover against the master address information to generate a list of one or more particular ones of the mailers that have the mover listed on their current address list, wherein the list of mailers was provided electronically to the mover. Finally, in response to receiving a change of address notification authorization from the mover identifying a selected one or more of the listed the mailers, the method includes notifying each of the selected mailers of the new contact information of the mover. The method may further include steps of generating an electronic change of address form including the list of particular mailers and electronically providing the electronic change of address form to the mover. The method may also further include electronically receiving the change of address notification authorization from the mover, wherein the change of address notification authorization is a completed version of the electronic change of address form.

Still another embodiment provides a method that is provided in conjunction with an electronic bill payment system through which a party makes payments to one or more payees. The method is a method of assisting the party to notify a selected one or more of the payees of one or more changes in contact related information for the party that includes receiving a request from the party to assist with a contact information change, in response to receiving the request, providing a list of the payees to the party, receiving a notification authorization from the party identifying the selected one or more of the payees, and providing to each of the selected one or more of the payees: (i) changed contact information for the party, and (ii) one or more pieces of information associated with the payee and the party which may be used by the payee to authenticate the party. The changed contact information may include one or more of a mailing address, a telephone number or an email address. Also, the one or more pieces of information associated with the payee and the party may include an account number and/or information relating to one or more transactions between the party and the payee.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a system which may be employed in implementing a method of facilitating an address change for one or more movers according to one or more embodiments of the invention;

FIGS. 2, 3 and 4 are flowcharts which illustrate various stages of one embodiment of a method for proactively updating the address list of a plurality of mailers according to the present invention;

FIG. 5 is a an example of a cover letter that may be employed in the method shown in FIGS. 2, 3 and 4;

FIG. 6 is an example form that may be employed in the method shown in FIGS. 2, 3 and 4;

FIG. 7 is a flowchart illustrating certain steps of a method for proactively updating the address list of a plurality of mailers that is initiated at the same time that a COA form is filed with the USPS by or on behalf of a mover according to another embodiment of the invention;

FIG. 8 is an example form that may be employed in the method shown in FIG. 7;

FIG. 9 is a schematic diagram of one particular system for facilitating address or other contact information changes according to another embodiment of the invention; and

FIG. 10 is an example web page that may be employed in an alternative embodiment of the invention.

### DESCRIPTION OF THE PREFERRED EMBODIMENTS

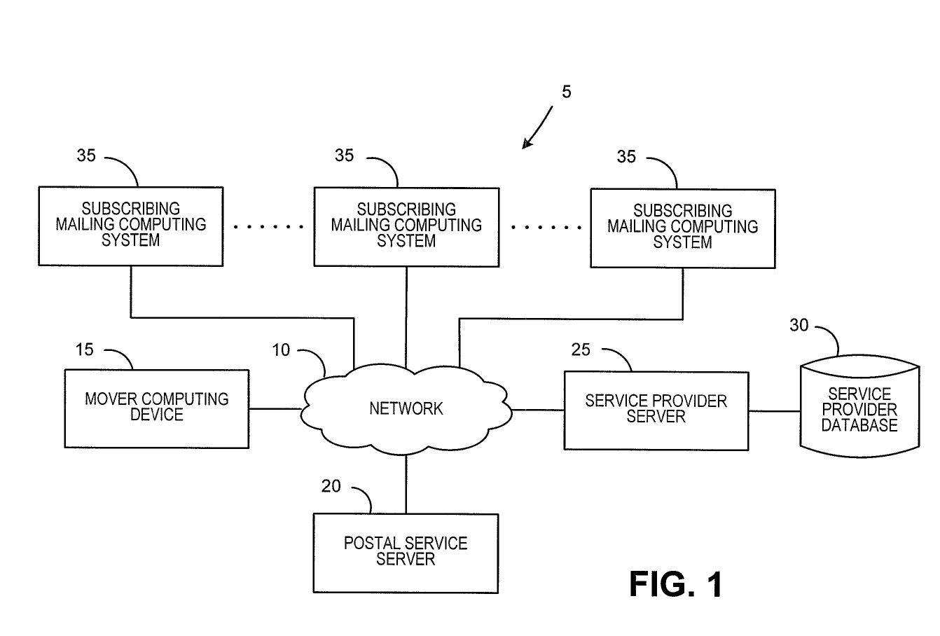

FIG. 1 is a block diagram of a system 5 which may be employed in implementing a method of facilitating an address change for one or movers according to one or more embodiments of the invention. The system 5 includes a communications network 10, which may be one or more wired and/or wireless communications networks alone or in various combinations, and may include, without limitation, the Internet. The system 5 further includes a mover computing device 15, such as a personal computer, a personal digital assistant or a cell phone, which is under the control and operation of an individual and/or business entity that is or has relocated or otherwise had a change of contact information, referred to herein as a “mover.” The mover computing device 15 is in electronic communication with the network 10 (wired or wireless). Although for illustrative purposes only one mover computing device 15 is shown in FIG. 1, it will be appreciated that multiple such devices and multiple movers are contemplated for the system 5. The system 5 further includes a postal service server 20, which may be a one or more server computers, one or more PCs, or a combination thereof. The postal service server 20 is under the control and operation of the local postal service, such as the USPS. For illustrative purposes, in certain embodiments the present invention will be described in the context of the USPS, but it should be understood that the invention is not limited thereto and may instead be implemented with other postal services worldwide. In addition, it should be noted that throughout the description herein, the postal service server 20 and the functions provided by the local postal service described herein may instead by provided by the third party service provider described below or some additional third party on behalf of the local postal service using a server (e.g., the service provider server 25 described below) under the control of the third party service provider or the additional third party (i.e., the functions may be outsourced by the local postal service). Therefore, the particular embodiment shown in FIG. 1 and described herein should not be considered to be limiting, but instead is meant to be exemplary in order to described the invention.

As is known, when a mover is relocating, the user may submit a change of address (COA) form with the USPS in order to have that mover's mail forwarded to the mover's new address. This may be done physically by the user by manually filling out a paper form and submitting it to the USPS. Alternatively, the mover may file a COA electronically, such as through the Internet, using the mover computing device 15 by completing an electronic form that is provided to the mover computing device 15 through the network 10 by the postal service server 20, and submitting the completed form to the postal service server 20 through the network 10.

Furthermore, the system 5 includes a service provider server 25, which may be one or more server computers, one or more PCs, or a combination thereof, which is in electronic communication with the network 10. The service provider server 25 is under the control and operation of a third party service provider that provides various services described elsewhere herein. The service provider server 25 is operatively coupled to a service provider database 30, the function of which is described elsewhere herein. Finally, the system 5 includes a plurality of subscribing mailer computing systems 35 which are under the control and operation of a plurality of mailers that wish to obtain the various address change services described herein. Each of the subscribing mailer computing systems 35 is in electronic communication with the network 10.

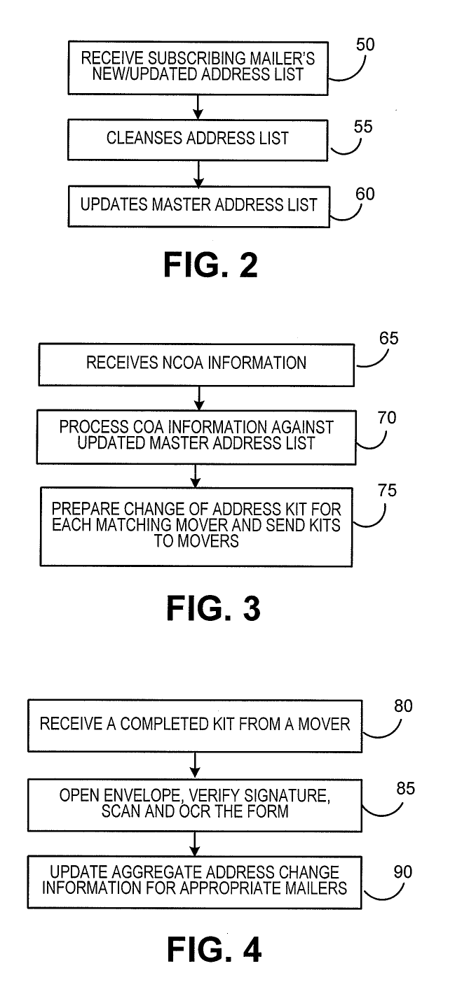

FIGS. 2, 3 and 4 are flowcharts which illustrate various stages of one embodiment of a method for proactively updating the address list of a plurality of mailers according to the present invention. The method of FIGS. 2, 3 and 4 involve a service that is provided by the third party service provider described in connection with FIG. 1. In particular, in this embodiment it is contemplated that each mailer will enter into an agreement, typically for a some pre-defined subscription fee, with the third party service provider in order receive the address change services that are described below.

Referring to FIG. 2, at step 50, once the mailer has subscribed to the service, the third party service provider receives from the mailer the mailer's current address list (e.g., customer mailing list). Preferably, the mailer sends the address list from the mailer's subscribing mailer computer system 35 to the service provider server 25 electronically through a secure channel established through the network 10. Once the address list is received, at step 55, the service provider server 25 cleanses the address list. Preferably, the cleansing is performed using known CASS/DPV methods. CASS stands for Coding Access Support System, which is a service that standardizes all address components of the address list and, if needed, assigns ZIP+4 coding. DPV stands for Delivery Point Validation, which is a service that validates the actual existence of an address beyond ZIP+4. Next, once the address list is cleansed, at step 60, the service provider server 25 updates a master address list that is maintained in the service provider database. The master address list is a list of all of the addresses that have been received by the third party service provider from each of the subscribing mailers (i.e., obtained from each received mailer address list) that is indexed according to mailer. Preferably, for reasons that will become apparent below, the master address list is optimized for NCOALink processing so that the comparisons associated with the described method take a fraction of the time they would take if all address lists had to be processed separately. As seen in FIG. 3 at step 50, in the preferred embodiment, each subscribing mailer will periodically send an updated address list to the third party service provider and steps 55 and 60 will be repeated so that the master address list can be as up-to-date as possible. The updated address list may be used to completely replace the existing addresses, thereby purging older address information. Optionally, the recent address corrections could be applied to the updated address list to flag pending changes to catch the possibility that the mover submits a corrected address change based on the old address.

Next, referring to FIG. 3, the master address list is processed against NCOA information on a periodic basis (e.g., weekly), in order to identify any relevant mover address changes. Specifically, when the processing occurs, the service provider server 20, at step 65, receives the then current NCOA information (which will include address changes filed over the last 48 months) from the postal service server 20 through the network 10. At step 70, the service provider server 25 then obtains the master address list from the service provider database 30 and compares the NCOA information to the master address list to determine whether any of the movers listed on the NCOA information are included in the master address list (and thus are on one or more current subscribing mailer address lists). At the end of step 70, the service provider server 25 will have generated a list of matching movers and for each such mover will also have identified the mailer or mailers that have that mover on their address list. Then, at step 75, the third party service provider will generate a change of address kit, described below, for each matching mover and send the kit to each mover.

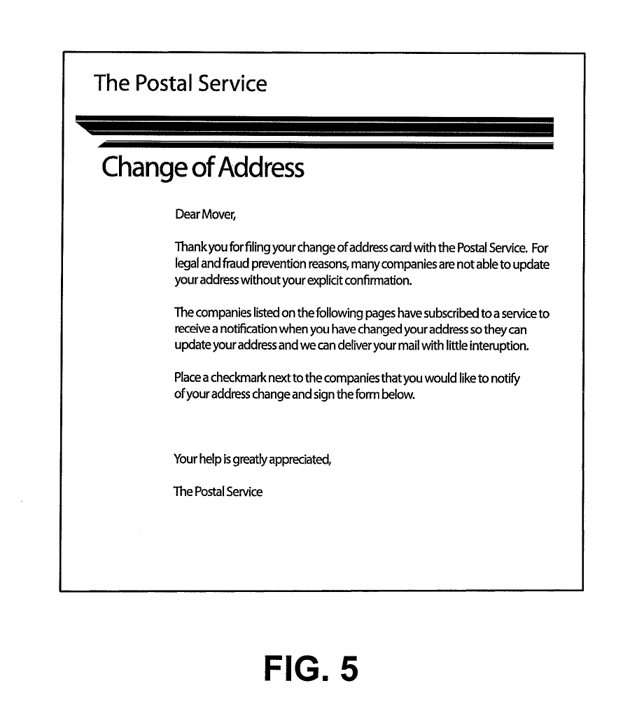

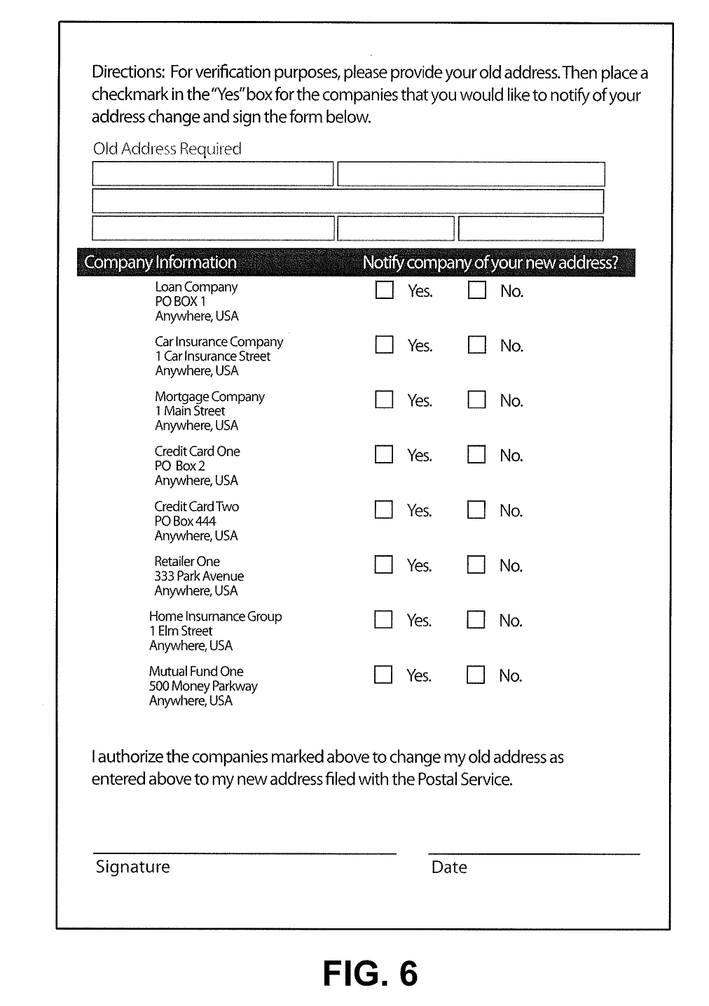

In particular, in the preferred embodiment, the kit that is generated in step 75 comprises a single, consolidated mailpiece that includes the following items: (i) a cover letter explaining the service and why it is necessary even though the mover has already submitted a change of address form to the USPS, (ii) a form that includes a listing of each mailer that has the mover on their address list, a check box for each such mailer that enables the mover to indicate that the mover desires the third party service provider to update the mover's address information for that mailer and a place for the mover to sign his or her name (for authentication purposes), and (iii) a business reply envelope (BRE) for returning the form to the third party service provider. An example cover letter is shown in FIG. 5 and an example form is shown in FIG. 6. If mailers require special forms, custom address change forms pre-printed with the mover's name, old address and new address can be included.

FIG. 4 shows the steps that are performed by the third party service provider when completed kits (which serve as change of address notification authorizations) are received from individual movers. At step 80, the third party service provider receives a completed kit (i.e., a completed form) from a mover, either in the mail or electronically (such as in the form of an attachment to an email or through a web interface). Next, the third party service provider processes the completed kit. Preferably, in the case of a kit received in the mail, this would include, as indicated at step 85, opening the envelope, verifying the signature on the form (preferably by comparing it to the signature that was provided on the completed COA form submitted by the mover to the USPS), scanning the form to create an image thereof, performing optical character recognition (OCR) on the form to determine which boxes have been checked (i.e., which mailers are to be notified of the address change), and archiving the image for possible later verification. According to an aspect of this embodiment, the third party service provider will maintain aggregate address change information for each of its subscribing mailers which includes current address changes for any entries present on that mailer's address list (i.e., any changes that have been identified since the last time changes were reported to the mailer as described below). Thus, at step 90, the method includes a step of updating the aggregate address change information for each identified mailer based on the information obtained from the completed form.

Finally, according to a further aspect of the present embodiment, the third party service provider will periodically transmit to each subscribing mailer the aggregate address change information for the mailer so that the mailer can make changes to its address list as appropriate. Preferably, this is done by transmitting that information electronically from the service provider server 25 to each subscribing mailer computing system 35 over the network 10 using a secure channel. Alternatively, rather than being transmitted periodically as just described, the address change information could be transmitted to each mailer as appropriate immediately after being identified from completed mover forms. Thus, according to the just described embodiment, mailers will automatically receive address change information for maintaining their address lists without having to initiate such action on their own.

Moreover, the concept of the kit comprising the single, consolidated mailpiece described above and shown in FIG. 5 could also be adapted to fit the needs of mailers that are unwilling to let their address lists out of their control. Typically, these mailers have an in-house solution for processing moves. In these cases, the mailers are already processing their lists on a regular basis and could provide the third party service provider with a list that just contains their customers who have moved so that the third party service provider could create kits for those customers. This would limit the exposure of mailers' address lists, but would enable them to still reap the benefit of a cost savings with the consolidated change of address mailpiece.

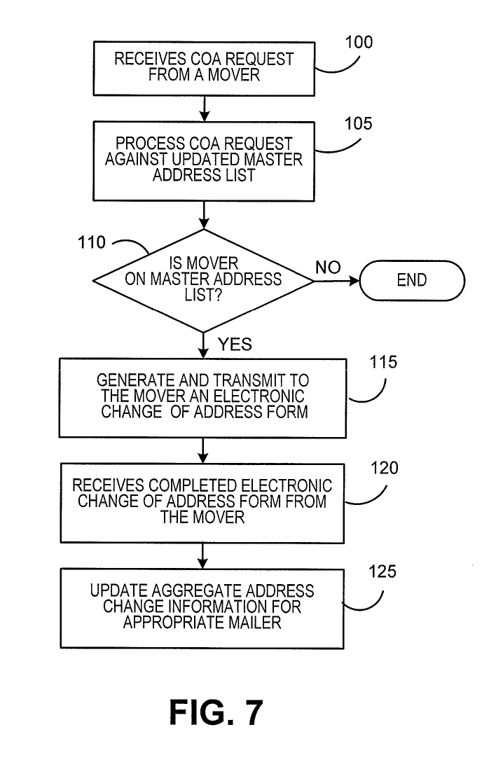

In an alternative embodiment, the present invention provides a method for proactively updating the address list of a plurality of mailers that is initiated at the same time that a COA form is filed with the USPS by or on behalf of a mover. In this embodiment, the method steps shown in FIG. 2 are performed so that the third party service provider will maintain a master address list as described elsewhere herein. However, rather than performing the steps shown in FIGS. 3 and 4, the method in this embodiment includes the steps shown in FIG. 7. In particular, at step 100, the USPS receives a COA form from a relocating mover. This may be done electronically by accessing an electronic COA form, such as a web-based form, through the network 10 from the postal service server 20 using the mover's mover computing device 15. Alternatively, the mover may file a form manually, in which case the information from the form will be input into the postal service server 20 by the USPS. The remaining steps of FIG. 7 still may be performed, but will remain pending until the postal service validates the COA form.

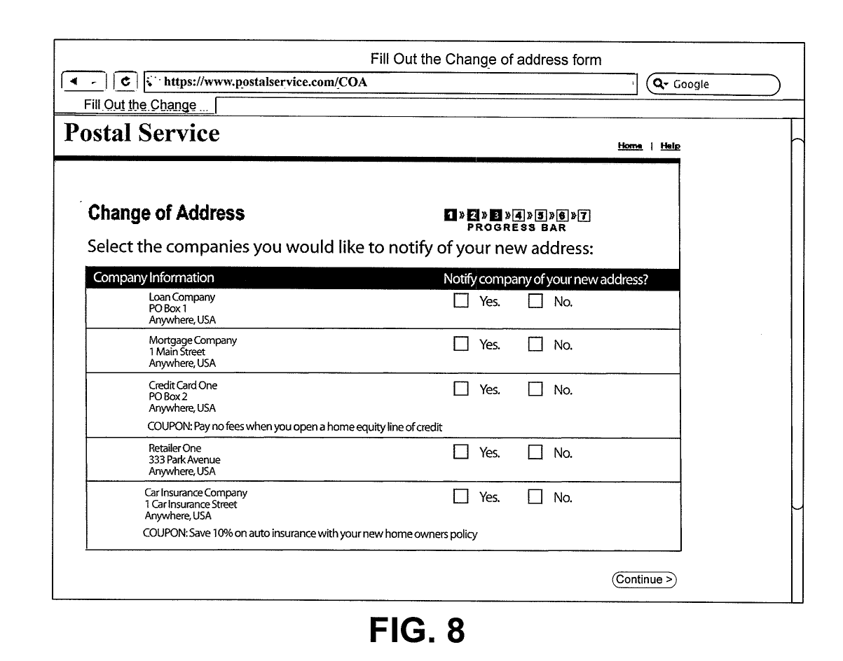

Next, at step 105, the COA request is processed against the master address list maintained by the third party service provider. In particular, in one particular embodiment, the postal service server 20 transmits the COA information for the mover to the service provider server 25 through the network 10 using a secure channel. The service provider server 25 then compares the received COA information to the master address list to determine whether the mover is included in the master address list (and thus is on one or more current subscribing mailers address lists). Based on this comparison, the service provider server 25 generates a list of mailers, if any, that have the mover on their current address list and transmits that list of mailers, or an indication that the mover is not included in the master address list, as appropriate, to the postal service server 20 through the network 10 using a secure channel. Upon receiving this information, the postal service server 20, as indicated at step 110, determines whether the mover was found on the master address list and thus needs to have a mailer-specific change of address form presented to them. If the answer at step 110 is no, then the method ends and the postal service server 20 waits for the next COA request to be received for processing as described herein. If, however, the answer at step 110 is yes, then, at step 115, the postal service server generates and electronically transmits to the mover (i.e., to the mover's mover computing device 15) an electronic mailer-specific change of address form, which is preferably a web-based form that is transmitted over the Internet. An example form is shown in FIG. 8 and includes a list of all of the mailers that had the mover listed on their address list. Preferably, check boxes are provided next to each listed mailer so that the mover can indicate whether that mailer should receive the mover's new address information.

At step 120, the postal service server 20 receives the completed mailer-specific change of address form from the mover through the network 10 (the form serves as change of address notification authorization). As was the case with the embodiment described in connection with FIGS. 2, 3 and 4, the third party service provider in this embodiment will maintain aggregate address change information for each of its subscribing mailers which includes current address changes for any entries present on that mailer's address list (i.e., any changes that have been identified since the last time changes were reported to the mailer as described below). Thus, in this embodiment, the completed form (or just relevant information obtained therefrom) is transmitted to the service provider server 25 through the network 10, and at step 125, the method of this embodiment includes a step of updating the aggregate address change information for each mailer that was selected by the mover on the electronic mailer-specific change of address form. The third party service provider will then periodically transmit to each mailer a file containing the aggregate address change information for the mailer so that the mailer can make changes to its address list as appropriate. Alternatively, instead of transmitting a file, the subscribing mailer computing system 35 could be directly updated with the address change information by the service provider server 25 through network 10. Preferably, this is done by transmitting that information electronically from the service provider server 25 to each subscribing mailer computing system 35 over the network 10 using a secure channel. Alternatively, the address change information could be transmitted to each mailer as appropriate immediately after the completed electronic address form or the information therefrom is received from the postal service server 20. Thus, according to the just described embodiment, mailers will automatically receive address change information for maintaining their address lists without having to initiate such action on their own. It should be appreciated that the address information described herein need not be limited to just mailing addresses, but instead may include other contact information such as phone numbers and/or email addresses. Thus, the term “new address” is not meant to be limited to new mailing addresses, but instead may include any such contact information.

Moreover, one place where many movers maintain a list of companies with specific account numbers is in financial institution software such as an electronic bill payment system like those implemented by banks or other financial institutions and those found in accounting software. According to a further embodiment, the present invention provides a method for enabling parties (such as an individual or a business entity) to change their address or other contact information for multiple mailers using a bill payment application that has the billing information needed to authenticate the mover to the mailer, including, without limitation, account numbers, addresses, and recent transactions. In this embodiment, the party has the ability to select which mailers should be notified of the new address. The mailers can then update their address lists before any lost or delayed communication with the party.

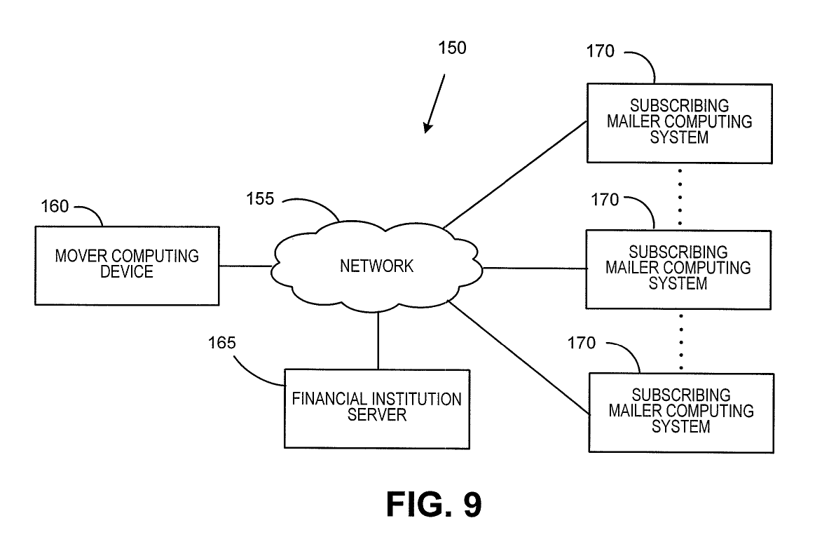

This embodiment contemplates that the party that implements the bill payment application will enter into agreements with various mailers to provide verified change of address information for some predetermined fee. FIG. 9 is a schematic diagram of one particular system 150 for facilitating address or other contact information changes according to this embodiment. The system 150 includes a communications network 155, which may be one or more wired and/or wireless communications networks alone or in various combinations, and may include, without limitation, the Internet. For illustrative purposes, this embodiment will be described in the form of a web based system using the Internet. This should not, however, be interpreted as limiting, as other network embodiments may also be employed. The system 150 further includes a mover computing device 160, such as a personal computer, a personal digital assistant or a cell phone, which is under the control and operation of a party (e.g., individual and/or business entity) that is or has relocated or has otherwise had a change of contact information. The mover computing device 160 is in electronic communication with the network 155 (wired or wireless). Although for illustrative purposes only one mover computing device 160 is shown in FIG. 9, it will be appreciated that multiple such devices and multiple parties are contemplated for the system 150.

The system 150 further includes a financial institution server 165, which may be one or more server computers, one or more PCs, or a combination thereof. The financial institution server 165 is under the control and operation of a financial institution or other entity that implements a bill payment application being used by the party. Finally, the system 150 includes a plurality of subscribing mailer computing systems 170 which are under the control and operation of a plurality of mailers that wish to obtain the address change services of the present embodiment. Those mailers will correspond to the payees described below. Each of the subscribing mailer computing systems 170 is in electronic communication with the network 155.

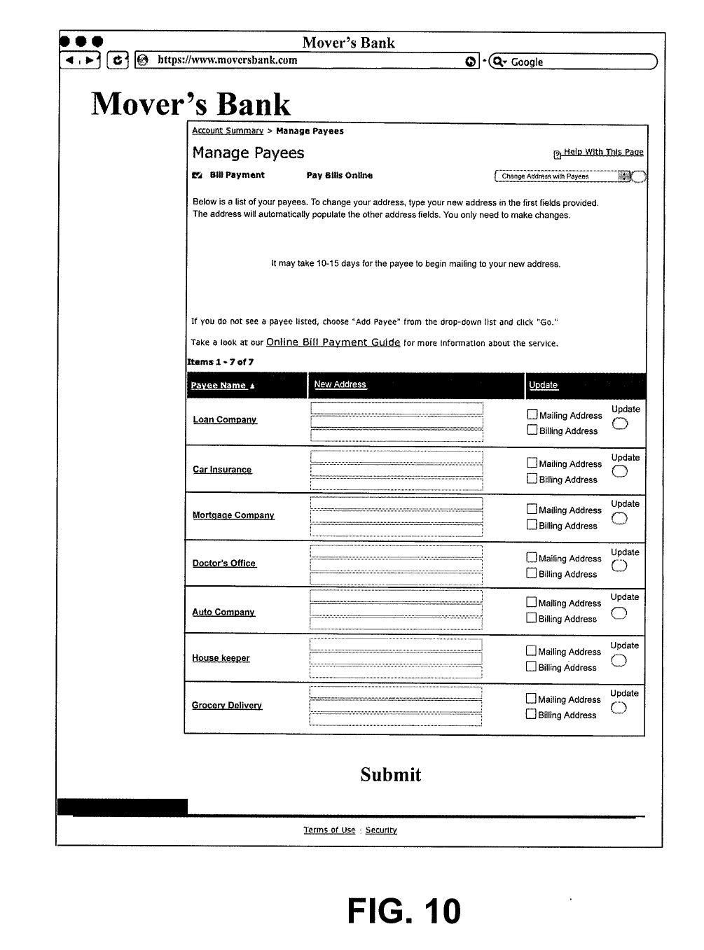

According to the present embodiment, when a party desires to change his or her address or other contact information (such as telephone number, email address, etc), the party will access a web site maintained by the financial institution server 165 using the party's mover computing device 160. The party will then need to be authenticated using a username and password or some other similar mechanism. As will be appreciated, the username and password or other mechanism will already be in place as they will need to be used by the party for authentication when using the bill payment system implemented by the financial institution. After authentication, the party's mover computing device 160 is presented with a web page for updating their address or other contact information with the financial institution. After completing this information, the party is presented with an option to change their information with their “payees” listed in the bill payment application. If the party decides to proceed with that option, they will be presented with another web page that allows the party to provide/select which address or contact information they wish to use with each listed payee. An example of such a web page is shown in FIG. 10. After the information is provided in the web page, the party may select the submit button. In response, the financial institution server 165 will transmit the new/changed address or other contact information to the appropriate subscribing mailer computing systems 170 through the network 155 using a secure channel (each payee will be one of the subscribing mailers described above). Preferably, the financial institution server 165 will also transmit one or more pieces of authentication information, such as an account number or recent transaction information to which it has access to the appropriate subscribing mailer computing systems 170 so that the mailers can authenticate the change request. In the alternative, instead of the financial institution server 165 sending the new/changed address or other contact information and the authentication information to the appropriate subscribing mailer computing systems 170, that function may be performed by an intermediary service provider after receiving that information from the financial institution server 165. Upon receiving the new/changed address or other personal information, each mailer can then update their address lists. Thus, in this embodiment, a moving party is able to simply and conveniently change their address or other contact information with multiple mailers without the need to gather information such as a way to contact the mailer (e.g., phone number, address or web site), an account number and/or recent transaction information.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of facilitating the maintenance of an address list of each of a plurality of mailers, comprising:
maintaining master address information based on current address list information received from each of said mailers;
receiving change of address information specifying a new address for each of a plurality of movers, said change of address information being based on a change of address filed by each of said movers;
comparing said change of address information to said master address information to determine a plurality of matching movers included in both said change of address information and said master address information;
providing each of said matching movers with a list of one or more particular ones of said mailers that have the matching mover listed on their current address list; and
for each of one or more responding matching movers: (i) receiving a change of address notification authorization from the responding matching mover, said change of address notification authorization identifying a selected one or more of said one or more particular ones of said mailers included in the list provided to the responding matching mover, and (ii) notifying each of the selected one or more of said one or more particular ones of said mailers of the new address of the responding matching mover.

2. The method according to claim 1, wherein said providing step comprises preparing a change of address kit for each of said matching movers, the change of address kit for each matching mover including a form that includes the list of one or more particular ones of said mailers that have the matching mover listed on their current address list, and sending each said change of address kit to the associated matching mover.

3. The method according to claim 2, wherein said sending step comprises mailing each said change of address kit to the associated matching mover.

4. The method according to claim 2, wherein the change of address kit for each matching mover further includes an explanatory letter.

5. The method according to claim 2, wherein the step of receiving a change of address notification authorization from the responding matching mover comprises receiving a completed version of the form included in the change of address kit sent to the responding matching mover.

6. The method according to claim 1, wherein said maintaining step comprises receiving said current address list information from each of said mailers and cleansing said current address list information before including any of said current address list information in said master address information.

7. The method according to claim 1, wherein said receiving step comprises receiving change of address information specifying a new address for each of the plurality of movers from a postal service or a third party working on behalf of the postal service.

8. A method of facilitating the maintenance of an address list of each of a plurality of mailers in response to a change of address request being provided by a mover that specifies new contact information for said mover, comprising:
maintaining master address information based on current address list information received from each of said mailers;
processing said mover against said master address information to generate a list of one or more particular ones of said mailers that have the mover listed on their current address list, said list of one or more particular ones of said mailers being provided electronically to said mover; and
in response to receiving a change of address notification authorization from the mover identifying a selected one or more of said one or more particular ones of said mailers included in the list of one or more particular ones of said mailers provided to the mover, notifying each of the selected one or more of said one or more particular ones of said mailers of the new contact information of the mover.

9. The method according to claim 8, further comprising generating an electronic change of address form including said list of one or more particular ones of said mailers and electronically providing said electronic change of address form to said mover.

10. The method according to claim 9, further comprising electronically receiving said change of address notification authorization from the mover, said change of address notification authorization being a completed version of said electronic change of address form.

11. The method according to claim 9, wherein said new contact information includes a new mailing address.

12. The method according to claim 9, wherein said new contact information includes a new email address or a new phone number.

13. In conjunction with an electronic bill payment system through which a party makes payments to one or more payees, a method of assisting said party to notify a selected one or more of said payees of one or more changes in contact related information for said party, comprising:
receiving a request from said party to assist with a contact information change;
in response to receiving said request, providing a list of said payees to said party;
receiving a notification authorization from the party identifying said selected one or more of said payees; and
providing to each of said selected one or more of said payees changed contact information for the party.

14. The method according to claim 13, wherein said providing step further includes providing to each of said selected one or more of said payees one or more pieces of information associated with the payee and said party which may be used by said payee to authenticate said party

15. The method according to claim 13, wherein said changed contact information includes one or more of a mailing address, a telephone number and an email address.

16. The method according to claim 14, wherein said one or more pieces of information associated with the payee and said party include an account number.

17. The method according to claim 14, wherein said one or more pieces of information associated with the payee and said party include information relating to one or more transactions between said party and the payee.

18. The method according to claim 13, wherein the changed contact information for each of said payees is the same.

19. The method according to claim 13, wherein the step of providing a list of said payees to said party comprises providing an electronic form to said party, said electronic form including said list of said payees and a mechanism for providing the changed contact information for each of said payees.

20. The method according to claim 19, wherein the changed contact information for each of said payees may vary among said payees.
